(19) United States
(12) Patent Application Publication
(10) Pub. No.: US 2020/0104861 A1
(43) Pub. Date: Apr. 2, 2020

(54) WEB-BASED SYSTEM FOR CUSTOMER RELATIONSHIP MANAGEMENT AND METHOD FOR OPERATING THE SAME

(71) Applicant: Henry Jia-Shuo Tsai, Laguna Hills, CA (US)

(72) Inventor: Henry Jia-Shuo Tsai, Laguna Hills, CA (US)

(21) Appl. No.: 16/148,643

(22) Filed: Oct. 1, 2018

(51) Int. Cl. G06Q 30/02; G06F 17/30; G06Q 50/00; H04L 29/08

(52) U.S. Cl. CPC G06Q 30/0201; G06F 17/30864; H04L 67/10; H04L 67/306; G06Q 50/01

(57) ABSTRACT

Provided herein is a web-based system for customer relationship management and a method for operating the system. The system provides a cloud computing system that includes a server initiating a web service, a CRM database associated with the cloud system for recording customer data, and a browser-based user device that launches a browser to log into the cloud computing system for accessing the CRM database. A browser is enabled in the user device to execute a script transmitted from the system for performing a method for operating the system. Through GUIs initiated by the browser while linking with the web service, the CRM database is more easily accessible. A user can obtain all kinds of information relating the customer, can easily reach the customers, and can instantly be made aware of and solve their problems through the web service so as to establish a close relationship with customers.

### FIELD OF THE DISCLOSURE

The present disclosure relates to a web-based tool for perform customer relationship management, and more particularly to a web-based system that provides a user interface with widgets, and also a method for operating the same.

### BACKGROUND OF THE DISCLOSURE

Customer relationship management (CRM) allows a person, a company or an organization to efficiently manage the information generated by interactions with his or their customers. The objective of of CRM is not only to maintain relationships with the customers, but also to discover potential customers. Many conventional CRM approaches perform data analysis for mining further information about the customers, including information of every individual customer and also the information of the customers as a whole. Finally, the CRM approaches can help the person, company or organization to improve business relationships with customers, and also help a business to grow.

Currently, many CRM systems still utilize Relational Database Management Systems (RDBMS) technology or the like to construct the data of individual customers, but they are always not compatible with many modern software tools that are commonly used among the users. For example, it is difficult for the conventional CRM systems to use or learn the data generated in social media since the traditional database of the RDBMS lacks the capability to integrate external information outside of their native data.

Thus, it would be desirable to provide a web-based user interface for a CRM system that allows a user to manage diverse data of the customer at any time or place. Through this kind of efficient management tool, the CRM can be more efficiently conducted by the user.

### SUMMARY OF THE DISCLOSURE

In response to the above-referenced technical inadequacies, the present disclosure provides a web-based system for customer relationship management and a method for operating the system.

In one aspect, the web-based system for customer relationship management in accordance with one of the embodiments of the present disclosure essentially provides a cloud computing system that includes a server initiating a web service, and a CRM database associated with the cloud system. The CRM database records customer data including basic information, at least one communication method, contact history, contact schedule and preference with respect to every customer. A customer profile for every customer can therefore be created. The system also provides a script transmitted to a browser-based user device that launches a browser to log in the cloud computing system for accessing the CRM database through the web service. The browser-based user device utilizes the browser to execute the script for performing a method for operating the web-based system.

In an aspect of the disclosure, while the browser-based user device performs the method using the browser, a GUI of customer management is initiated, and customer data is downloaded from the cloud computing system according to search criteria. The customer data can be modified by an authorized user logging into the system according to a current status of each of the customers. Through the script executed by the browser, the user can perform the method through the GUIs. When the customer data is uploaded to the server, the program running in the system can identify and classify the customer data. Through the GUIs, a list of tracking events of the customer with respect to every customer data that is modified is generated.

Further, after the customer data is downloaded, a reminder relating to a time-based event with respect to one of the customers is generated, and a GUI for showing one or more latest events relating to the customer can also be initiated.

Still further, a contact page including a list of communication methods related to the customer can also be provided when the one or more latest events is shown through the GUI.

Further, after initiating the GUI of customer management, a GUI for querying customer profile is initiated for the authorized user to input the search criteria including any one or combination of a name, an ID, a time, and an event.

In another aspect of the present disclosure, a method for operating a web-based system for customer relationship management is provided. In a browser-based user device, a GUI of customer management is initiated while launching a browser to log into a cloud computing system for accessing a CRM database through a web service. In the method, the user device downloads customer data from the cloud computing system according to search criteria, records the customer data that is modified by an authorized user, and the customer data is uploaded to the server for identifying and classifying the customer data. A customer profile with respect to the customer data that is modified is therefore updated.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a web-based system for implementing CRM according to one embodiment of the present disclosure;

FIG. 2 shows another schematic view depicting functional modules of the web-based for CRM according to one embodiment of the present disclosure;

FIG. 3 shows a flow diagram describing a method for operating the web-based system for CRM in one embodiment of the present disclosure;

FIG. 4 shows another flow diagram describing the process of linking social media data in the system in one embodiment of the present disclosure;

FIG. 5 shows one further flow diagram describing the process operated in the system in one further embodiment of the disclosure;

FIG. 6 shows a flow diagram describing a process of initiating messaging function in the system according to one embodiment of the present disclosure;

FIG. 7 shows a flow diagram describing a messaging process using customized messages in the system in one embodiment of the present disclosure;

FIG. 8 shows a schematic view of a web page relating to customer data in the system in one embodiment of the present disclosure;

FIG. 9 shows another schematic view of a web page relating to customer profile in one further embodiment of the present disclosure;

FIG. 10 shows one further schematic view of a web page relating to information of a customer in one embodiment of the present disclosure;

FIG. 11 shows a schematic view of a web page showing a contact history of a customer in one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is related to a web-based system for Customer Relationship Management, hereinafter ‘CRM’, and a method for operating the system. The present disclosure introduces a series of web widgets of the web-based system through a web service with graphical user interface (GUI) design. These web widgets are preferably shown as a plurality of graphical icons on web pages initiated by the system. Further, the GUI-based web pages allow a user, e.g. an administrator of the system, to manage customer data more efficiently.

Further, according to one embodiment of the disclosure, the web-based CRM system can be implemented by a cloud computing system with a CRM database and one or more user-end computers. The cloud computing system is an assembly of a plurality of computers, servers and storage. An http service running in the system initiates a series of web pages acting as user interfaces for the user to conduct CRM. The web-based system for customer relationship management of the present disclosure essentially includes an aspect for processing customer data, including data acquisition, analysis, classification, criteria to search and data presentation, and another aspect of GUI tools therefor.

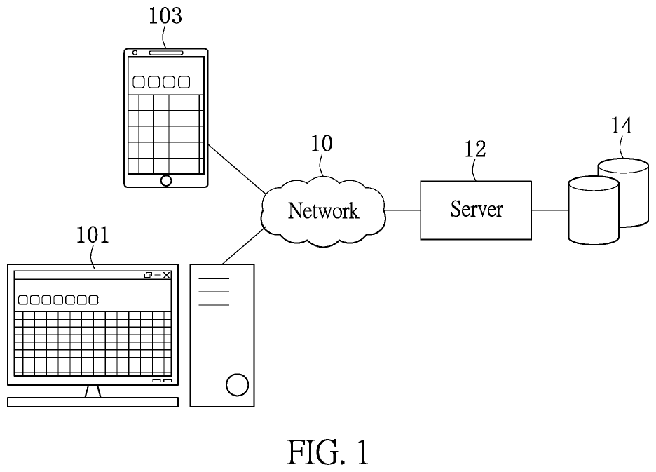

Reference is made to FIG. 1 that shows a schematic view of a web-based system for implementing CRM according to one embodiment of the present disclosure.

A web-based CRM system is provided in an aspect of the present disclosure. The system includes a server 12 that embodies a cloud computing system, and a web service is initiated in the server 12. The system includes a database 14 that embodies a CRM database of the system. It should be noted that the web service initiated in the server 12 is used to initiate a GUI system that renders various web page with graphical user interfaces (GUIs) in the browser-based user devices, e.g. the terminal devices 101 and 103. A script will be transmitted to the browser-based user device via a network 10, and the script is executed by a browser in the user device. The database 14 of the system is associated with the server 12. The database 14, e.g. the CRM database, records customer data including basic information, at least one communication method, contact history, contact schedule and preference with respect to every customer and then creates a customer profile for every customer.

The mentioned browser-based user device can be any type of the user device, such as the shown terminal devices 101 and 103. An operating system running in the user device launches the browser that allows a user to log in the server 12 for accessing the database through the web service. The system of the present disclosure makes the customer data recorded in the CRM database become easy to access, especially through GUIs that includes a variety of widgets, icons, tables, and windows. Therefore, the system allows the customer data to be created or updated through the browser more conveniently. After that, the modified customer data will be uploaded to the server 12.

In the browser-based user device, the browser is used to execute the script transmitted from the cloud computing system for performing a method for operating the web-based system. The script is used to interact with the web service initiated by the server 12 and access the database 14.

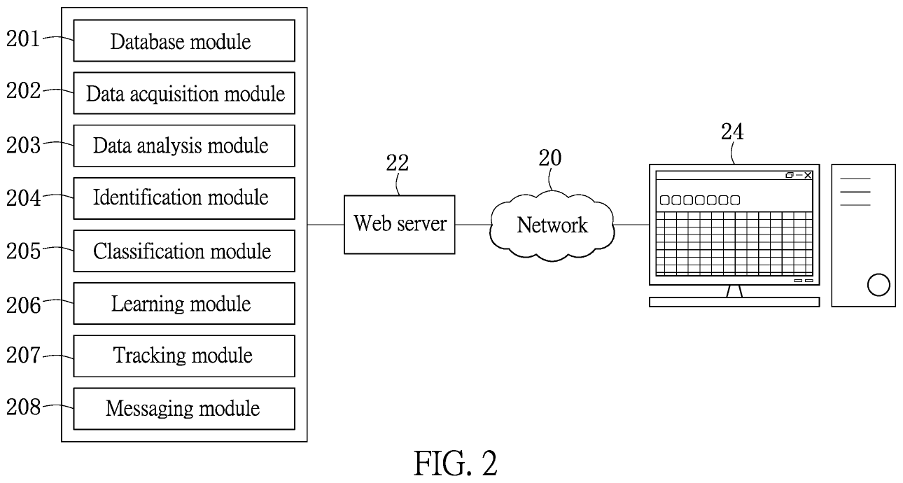

Reference is next made to FIG. 2 that shows another schematic view depicting functional modules of the web-based for CRM according to one embodiment of the present disclosure. In the diagram, the cloud computing system initiates a web server 22 that renders a series of web pages, e.g. the user-end web page 24, allowing the user to operate the system via a network 20.

The cloud computing system includes a server that is implemented by software functions as shown in the diagram. For example, a database module 201 forms a CRM database that collects the data, especially the customer data, uploaded from the terminal devices. A data acquisition module 202 acts as a web service via an HTTP protocol for collecting data uploaded from the terminal device, especially collecting the newly-created customer data and the updated customer data, so as to establish the CRM database of the system. A data analysis module 203 is implemented by a specific data-analysis program for analyzing the data uploaded from the terminal devices.

In should be noted that the data analysis is a process aiming at inspecting, transforming and modeling the data for discovering useful information, e.g. mining deeper information of the customer data. Data mining is a particular data analysis technique that focuses on modeling the customer profiles with respect to customers in the system in accordance with the embodiment of the present disclosure. The data analysis technique also includes data identification performed by an identification module 204 for identifying useful information from the diverse customer data, and data classification performed by a classification module 205 in the system for classifying the customer data is based on the identified data. For example, data classification can be based on various statistical methods and may be used to generate models for predicting the customers' behaviors.

When the customer profiles with respect to the various customers have been created, a data mining and learning can be implemented. A learning module 206 of the system can be used to learn every customer based on his proprietary data recorded in the data module 201, and also learn the behavior and trends of the customers as a whole. In an exemplary example, the learning module 206 performs a machine learning process that uses statistical techniques to focus on predicting the customer's behavior according to the models from input data relating to the customers.

Further, a tracking module 207 allows the user to track the events relating to every individual of the customers, for example for promoting the business development, according to a list of tracking events of the customers. A messaging module 208 in the system is implemented by a software progress that initiates any of communication methods available to every customer. The messaging module 208 allows the user using the user-end terminal device to establish an available messaging channel with each of the customers according to their preferences. For example, the messaging module 208 can automatically activate an instant messaging method by an instruction from the web server 22 when the user browses a customer profile indicating that the customer is accustomed to using instant messaging software. Moreover, the messaging module 208 can activate a telephone keypad on the user-end terminal device for the user to dial a telephone number for the customer if the customer profile indicates that the customer is accustomed to using the traditional telephone or mobile phone.

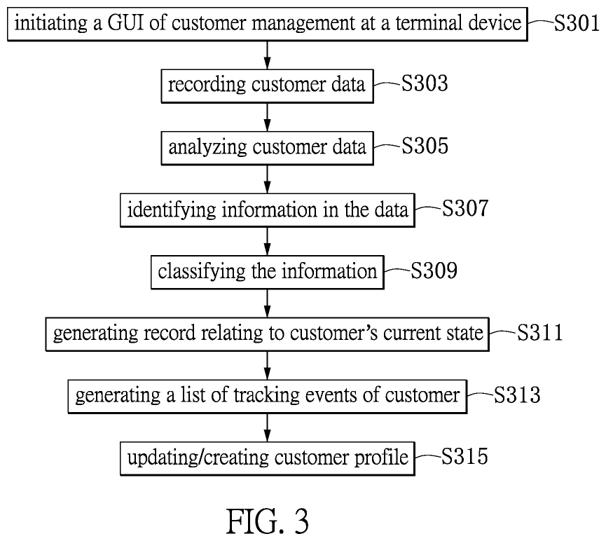

Next, FIG. 3 shows a flow diagram describing a method for operating the web-based system for CRM in one embodiment of the present disclosure. The web-based CRM system allows the user using the terminal device to access the CRM database via a browser. In step S301, when the user uses the browser to establish an HTTP connection with a server of the system, a GUI of customer management is initiated. The user should be an authorized user with respect to the web service. The system allows the authorized user to download the customer data according to an authorized account while logging in the web service. The user then selects one or more customer profiles according to his level of authorization, and modifies the records if necessary. The customer data is then recorded, such as in step S303, and uploaded to the server. The software process running in the server will analyze the customer data, especially the newly-modified data (step S305), and identify information in the customer data, such as in step S307. The information extracted from the customer data will be stored in the CRM database, and the information can be classified into various categories (step S309).

For example, for the purpose of customer relationship management in the system, the data classification is based on models established by the system according to history data of the customers. The record relating to customer's current status is generated through the browser used by the user (step S311). In step S313, a list of tracking events of customer can be generated. The web-based CRM system allows the user, e.g. an administrator, an operator, a director or a boss, to acknowledge the situation of every customer more easily. Also, the computer technology allows the system to track every event relating to each of the customers automatically, and then provide the list of tracking events. The list assists the user to conduct CRM more efficiently. In step S315, a customer profile for each of the customers is created, or updated if already existent in the CRM system.

It should be noted that the above-mentioned customer data analysis, identification and classification embody a behavior analysis and achieve a purpose of learning the individual customer's behavior or an overall behavior of customers. The behavior analysis seeks to understand the behavior of individuals or mass behavior, especially the overall behavior of customers toward a company. Furthermore, the behavior analysis through the web-based CRM system in accordance with the present disclosure allows the user to acknowledge individual customer's characteristics, or many customers' characteristics, especially the different types of customers. Therefore, the user can understand/take care of every customer's need and also conduct accurate marketing for each of the customers for improving customer adhesion.

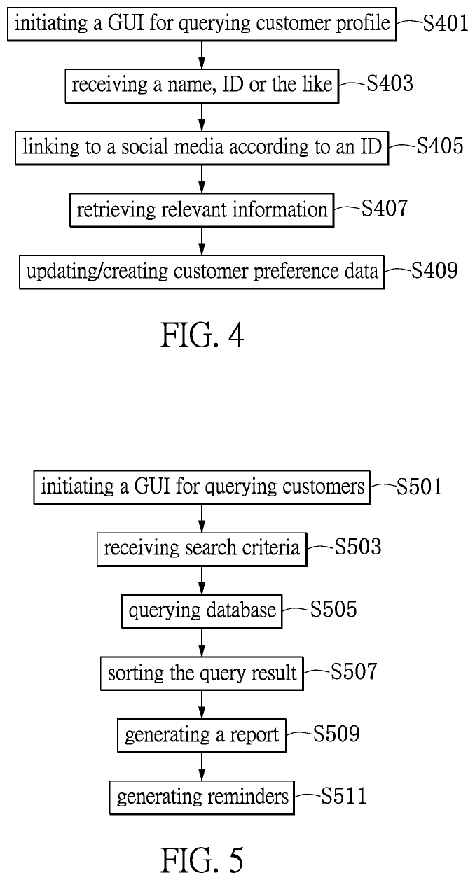

Furthermore, the system also allows the user to learn more about the customers from social media. Referring to FIG. 4, another flow diagram describing the process of linking social media data in the system in one embodiment of the present disclosure is shown.

When the user uses the browser to browse the customer profile, a function icon or widget allows the user to collect information from the open data of a social media according to the customer's account. In step S401, a GUI for querying customer profile is initiated. In step S403, a name, ID or the like can be used to link to a social media according to an ID (step S405). Through an application programming interface (API), the software process running in the server can access the open data from the social media, and the relevant information can be retrieved (step S407). Based on the customer data and his relevant data in social media, a customer preference can be effectively created. In step S409, the customer preference data is created or updated if the preference already exists.

FIG. 5 shows one further flow diagram describing the process operated in the system in one further embodiment of the disclosure.

In this flow diagram, in step S501, a GUI for querying customers is initiated. The system provides a search function through the GUI shown on the web page. The system can provide the information according to search criteria set up by the user (step S503). When receiving the search criteria from the terminal device, the software process running in the server queries the CRM database (step S505), and provides a search result. If it is necessary to the purpose of management, the related customer data can be downloaded from the cloud computing system according to the search criteria. It should be noted that, after initiating the GUI of customer management, the GUI for querying customer profile is initiated for the authorized user to input the search criteria including any one or combination of a name, an ID, a time, and an event.

On the web page initiated by the browser of the terminal device, the search result is sorted and displayed (step S507), and also a report is generated (step S509). When the user searches the data of one or more customers, related reminders can be generated (step S511) for reminding the user to acknowledge the situation of the customers he searches for. It should be noted that the reminder can be related to a time-based event with respect to one of the customers. The time-based event can be originally created in a schedule by the user, and the system can automatically give the reminder according to the schedule.

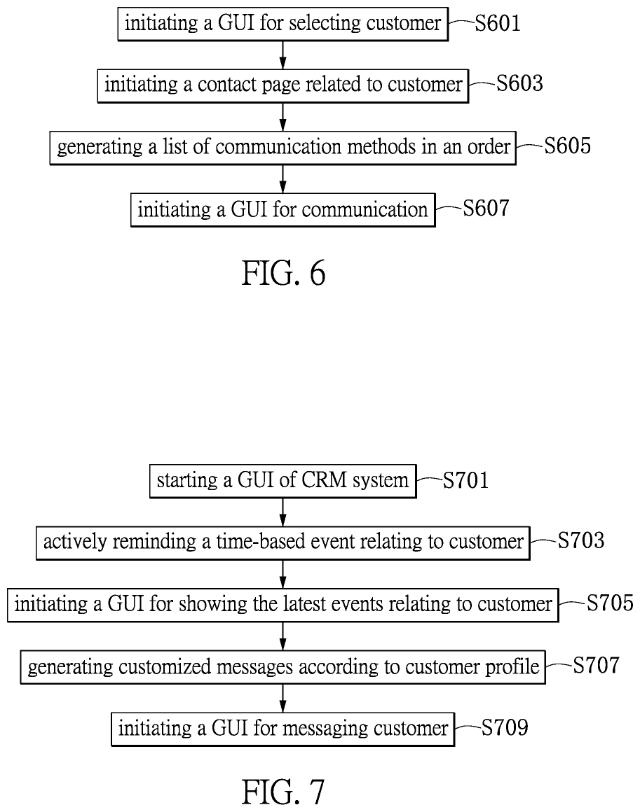

Next, FIG. 6 shows one further flow diagram describing a process of initiating messaging function in the system according to one embodiment of the present disclosure.

In step S601, a GUI for selecting customer is initiated when the user turns the customer management web pages and selects one of the customers. In step S603, a contact page illustrating the contact history related to the customer and the communication methods provided by the customer in the registration stage is initiated. In step S605, a list of communication methods is generated in order and provided for the user to select. In step S607, a GUI for communication is initiated.

When the GUI for communication is initiated, the GUI may be related to a preferred messaging program for communicating with the customer. The messaging program can be automatically enabled and ready to contact the customer while the user initiates the web page of the customer profile. Alternatively, the messaging program can also be enabled with the reminder associated with the time-based event for being ready to contact the customer.

The messaging program activated by the system can be referred to the flow diagram shown in FIG. 7.

In the beginning, such as in step S701, the user can start a GUI of CRM system and the system can actively remind a time-based event relating to one of the customers, such as in step S703. In step S705, a GUI for showing the latest one or more events relating to customer can be shown on the web page while accessing the customer profile. In the meantime, a messaging program can be enabled for reaching the customer. In step S707, the system can generate customized messages and deliver the messages to the terminal device according to the customer profile. It should be noted that the customized messages are proprietary to the customer when the software process running in the server recommends the messages based on the customer profile, his history, the reminding event, and the current status of the customer.

After that, in step S709, a GUI for messaging customer will be generated. The user can conveniently send the customized messages to the customer. The user can also input a new message or modify the message for reaching the customer. While messaging the customer, a list of tracking events of the customer can also be referred to. The system can provide suggestions or reminders to the customer of critical events according to the list of tracking events. In the meantime, the user can also modify the customer data if necessary. The customer data that is modified by an authorized user according to a current status of each of the customers can be recorded, and provided for the system to update the customer profile with respect to the customer data that is modified.

The following descriptions are about some schematic views of a series of web pages with GUIs relating to customer relationship management.

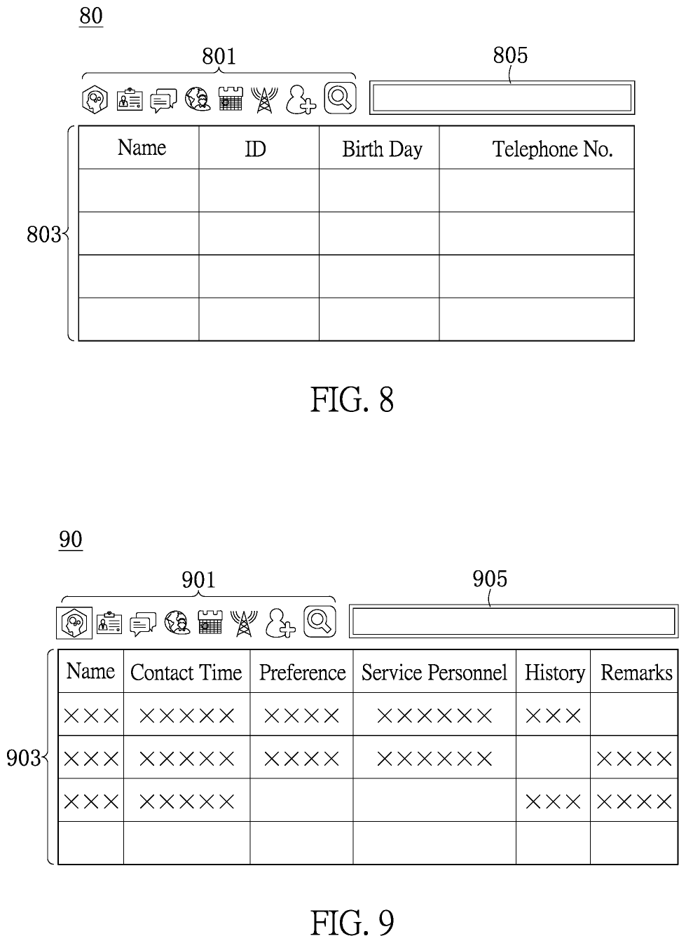

In FIG. 8, a customer data page 80 is schematically shown. A variety of function buttons 801 are provided for the user to create or update the profile of the customer. The user can select and activate any of the functions. For example, the function buttons 801 form the hot keys for activing a messaging process, browsing the customer profile, making a reservation, and linking to a social media. A customer list 803 including basic information of a list of customers is shown in the diagram. A search field 805 is also provided for the user to perform a search.

FIG. 9 shows another schematic view of a web page relating to customer profile in one further embodiment of the present disclosure. A customer profile page 90 is schematically shown. A similar function button 901 is also shown on the web page. A series of fields of customer profiles 903 are provided. The field lists some of the customers and their brief information such as name, a contact time, preference, service personnel, history and remarks. The search field 905 provides the user to input search criteria therein.

It should be noted that the fields may provide the user with the reminding information, e.g. the time-based event, relating every customer, and allow the user to make an instant reminder to the customer. Further, the fields of the customer profile also provide the history on past events that the customers act on.

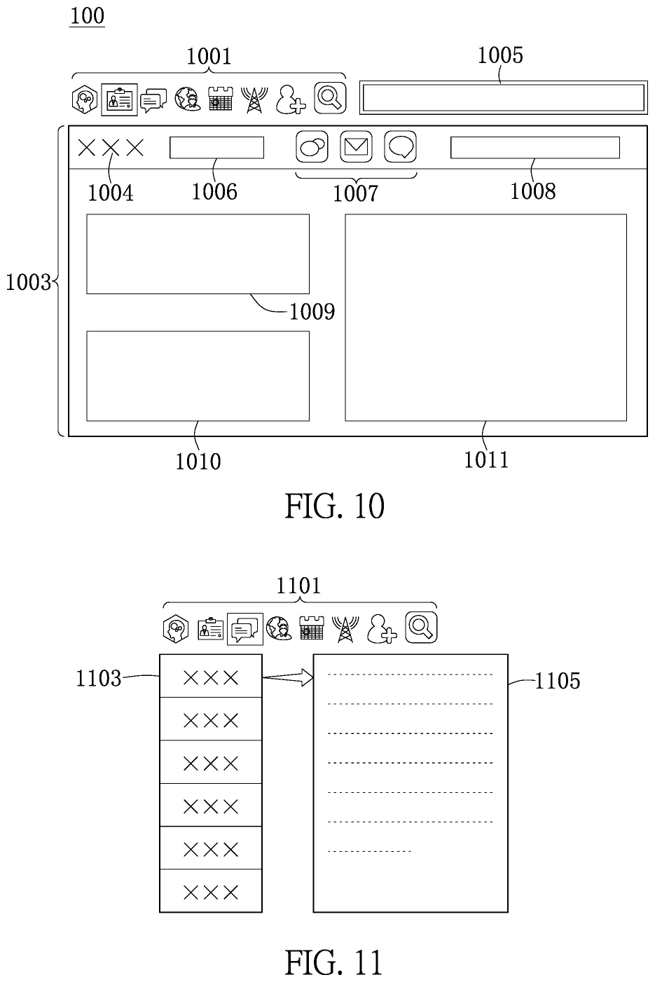

FIG. 10 further shows a schematic view of a web page relating to customer profile for each of the customers. An individual data page 100 is shown in the diagram. The function buttons 1001 are provided for the user to conveniently activate one of the functions. A search field 1005 is provided for inputting search criterial for querying the CRM database of the system. The field of the customer profile 1003 includes a name 1004, customer data 1006, communication methods 1007 that may include a plurality of contact ways suitable for the customer, service information 1008 that gives a brief account of past services, customer profile 1009, contact history 1010 and service history 1011. The customer profile 1003 is provided according to the user's selection. The customer profile 1003 helps the user to quickly view customer information.

The web page shown in FIG. 11 is related to a contact history of a customer in one embodiment of the present disclosure. The web page also provides a series of function buttons 1101 for the user to easily activate one of the functions. A customer list 1103 is provided for the user to select one of the customers according to the brief information shown in the list 1103. While selecting one of the customers, a contact history 1105 is displayed in a side column. The contact history 1105 retrieved from the CRM database allows the user to recall the latest status of a specified customer.

Therefore, the user can activate the messaging function by clicking one of the function buttons 1101 and initiate a contact page with a list of communication methods related to the customer. In an exemplary example, one of the communication methods can be activated automatically according to a customer preference that is rendered based on a communication history with respect to the customer. As described above, the system can also provide one or more customized messages according to the customer profile, the current status, the reminding event and the contact history. That is, it should be noted that the customized message at least combines the customer's name and a message that is rendered based on the time-based event and the customer profile.

According to one of the embodiments of the present disclosure, the web-based system for customer relationship management is applicable to a company, a hospital, a studio, and the like for enhancing their CRM. For example, when the system is adapted to a medical beauty clinic, the customer relationship can be effectively enhanced since the system can actively track the customers based on their history of medical appointments and the current status. The user of the system at the user-end terminal device is such as a consultant of the clinic, and the consultant can rely on the web-based system and the CRM database to establish a list of contact plans and continuously update the records of the customer profiles.

The system also allows the consultant to generate a report relating to a pivot analysis statistical chart based on the customer data in order to facilitate the customer maintenance and business development. The above-mentioned messaging function allows the consultant to send a large number of messages to a plurality of customers using their customized messages that can be suggested by the system. By the messaging function, the consultant can reach the customer more efficiently and at the right time since the system will remind an expected contact time with a right staff that is in connection with a next treatment/estimated time of appointment in the clinic. The system will actively arrange the contact time according to the expected contact time. Even if the contact time is expired, the system will generate a reminder for the consultant to arrange a next contact time. Therefore, it may be necessary for the system to render a contact plan automatically.

In conclusion, the above-referenced disclosure is generally related to a web-based system for customer relationship management and a method for operating the system. The system provides the cloud computing system and the CRM database for recording, analyzing, identifying, classifying and learning the customer data. The browser-based user device can easily access the understandable customer data through a browser initiated in the user device. Specifically, a script transmitted from the system is executed by the browser for operating the system through GUIs. The GUI system allows the user to easily access the CRM database to obtain all kinds of information relating the customer. The user can therefore establish a close relationship with customers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A web-based system for customer relationship management, comprising:
a cloud computing system that includes a server initiating a web service;
a CRM database associated with the cloud system, recording customer data including basic information, at least one communication method, contact history, contact schedule and preference with respect to every customer and creating a customer profile for every customer;
a browser-based user device that launches a browser to log in the cloud computing system for accessing the CRM database through the web service, creates or updates the customer data through the browser, and uploads the created or updated customer data to the cloud computing system; wherein the browser-based user device utilizes the browser to execute a script transmitted from the cloud computing system for performing a method for operating the web-based system comprising:
initiating a GUI of customer management;
downloading customer data from the cloud computing system according to search criteria;
recording the customer data that is modified by an authorized user according to a current status of each of the customers;
identifying and classifying the customer data after analyzing the customer data;
updating a customer profile with respect to the customer data that is modified; and
generating a list of tracking events of customer with respect to every customer data that is modified.

2. The system according claim 1, wherein the cloud computing system provides the customer data to the browser-based user device according to an authorized account that is used for the browser-based user device to log into the system.

3. The system according to claim 2, wherein, after the customer data is downloaded, a reminder relating to a time-based event with respect to one of the customers is generated.

4. The system according to claim 3, wherein, when the reminder is generated, a GUI for showing one or more latest events relating to the customer is initiated.

5. The system according to claim 4, further comprising initiating a contact page including a list of communication methods related to the customer when the one or more latest events is shown through the GUI.

6. The system according to claim 5, further comprising automatically activating one of the communication methods related to the customer according to a customer preference that is rendered based on a communication history with respect to the customer.

7. The system according to claim 3, wherein, when the reminder is generated, a GUI for messaging one of the customers is initiated, and one or more customized messages are also generated according to the customer profile.

8. The system according to claim 7, wherein the customized message at least combines the customer's name and a message that is rendered based on the time-based event and the customer profile.

9. The system according to claim 2, wherein, after initiating the GUI of customer management, a GUI for querying customer profile is initiated for the authorized user to input the search criteria including one or a combination of a name, an ID, a time, and an event.

10. The system according to claim 9, wherein, after one of the customers is selected by the authorized user, the script executed by the browser enables a link to a social media according to an ID of the customer, and retrieves relevant information with respect to the customer.

11. A method for operating a web-based system for customer relationship management, comprising:
in a browser-based user device, initiating a GUI of customer management while launching a browser to log in a cloud computing system for accessing a CRM database through a web service initiated by the cloud computing system;
downloading customer data from the cloud computing system according to search criteria when a script transmitted from the cloud computing system is executed by the browser;
recording the customer data that is modified by an authorized user according to a current status of each of the customers;
identifying and classifying the customer data after analyzing the customer data;
updating a customer profile with respect to the customer data that is modified; and
generating a list of tracking events of customer with respect to every customer data that is modified;
wherein the cloud computing system includes a server that initiates the web service, and the CRM database is associated with the cloud system for recording the customer data including basic information, at least one communication method, contact history, contact schedule and preference with respect to every customer and creating a customer profile for every customer.

12. The method according claim 11, wherein the cloud computing system provides the customer data to the browser-based user device according to an authorized account that is used for the browser-based user device to log into the system.

13. The method according to claim 12, wherein, after the customer data is downloaded, a reminder relating to a time-based event with respect to one of the customers is generated.

14. The method according to claim 13, wherein, when the reminder is generated, a GUI for showing one or more latest events relating to the customer is initiated.

15. The method according to claim 14, further comprising initiating a contact page including a list of communication methods related to the customer when the one or more latest events is shown through the GUI.

16. The method according to claim 15, further comprising automatically activating one of the communication methods related to the customer according to a customer preference that is rendered based on a communication history with respect to the customer.

17. The method according to claim 13, wherein, when the reminder is generated, a GUI for messaging one of the customers is initiated, and one or more customized messages are also generated according to the customer profile.

18. The method according to claim 17, wherein the customized message at least combines the customer's name and a message that is rendered based on the time-based event and the customer profile.

19. The method according to claim 12, wherein, after initiating the GUI of customer management, a GUI for querying customer profile is initiated for the authorized user to input the search criteria including one or a combination of a name, an ID, a time, and an event.

20. The method according to claim 19, wherein, after one of the customers is selected by the authorized user, the script executed by the browser enables a link to a social media according to an ID of the customer, and retrieves relevant information with respect to the customer.
